(19) United States
(12) Patent Application Publication
(10) Pub. No.: US 2003/0058447 A1
(43) Pub. Date: Mar. 27, 2003

(54) Colorimeter apparatus for color printer ink

(75) Inventors: Takeo Yamada, Yokohama-shi (JP); Tomoyuki Kobayashi, Yokohama-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: NIRECO CORPORATION, Tokyo (JP)

(21) Appl. No.: 10/215,102

(22) Filed: Aug. 8, 2002

(30) Foreign Application Priority Data
Aug. 14, 2001 (JP) 2001-245845

(51) Int. Cl. G01J 3/51

(52) U.S. Cl. 356/402; 356/416

(57) ABSTRACT

The present invention provides a colorimeter apparatus for a color printer ink capable of rapidly measuring the colors of a color patch portion in an online mode. The light of a xenon light source 21 is directed via an optical fiber 22 and a condenser lens 23 to a zone through which a color patch 53 passes. Reflected light is condensed by a telecentriclens system 14 and focused on the light-receiving surface of a Linear Variable Filter 11. The light is spectrally divided by the Linear Variable Filter 11 and guided toward a linear sensor 13 via a fiber optic plate (FOP) or collimator 12. The output of the linear sensor 13 is converted to an analog signal by an analog signal generator 14 and sent to a signal processor 3. In the signal processor 3, a spectral reflectance factor is calculated based on the resulting spectral reflectivity, and a color or color difference is calculated based on this value and a prestored formula for color systems or color differences.

### BACKGROUND OF THE INVENTION

1. Field of the Invention

The present invention relates to an apparatus whereby the color changes of a color ink are measured in an online mode during printing with a gravure printer, offset printer, flexo printer, or other color printer.

2. Description of the Related Art

Four- to five-color inks are commonly used in gravure printers, offset printers, flexo printers, and other color printers, and the colors of these inks vary slightly during printing, sometimes causing the actual printed colors to vary as well. A technique such as the one described in Japanese Patent Application Laid-open No. H8-132595 is known as a conventional method for detecting such color variations and stabilizing the printed color.

This method is a control method used in sheet-fed offset printers such that a color detection zone is established outside the printing range, a color patch is printed therein, the spectral reflectivity of the color patch portion is measured in an online mode by a reflectometer, the colors of the color patch portion are detected by color calculation, and a signal is sent to an ink feed adjustor such that the colors remain constant.

Stringent limitations have recently been imposed in relation to the color tone variations in gravure printing. According to these limitations, color detection zones (color patches) are established in columns composed of register markings, color variations are detected in an offline mode for these color patch areas either visually or by the use of a simple colorimeter, and ink toning is performed if variations are detected, thereby preventing inferior products from being produced.

According to the technique disclosed in Japanese Patent Application Laid-open No. 2000-146860, reflectivity is directly determined for a print pattern in the visible or near-infrared region, and the color tone variations of the print are measured in an online mode. Adopting this approach makes it possible to prevent useless zones from being formed on a print by the printing of color patches.

Japanese Patent Application Laid-open No. H09-126890 discloses a method in which a diffraction grating is used to measure a reflection spectrum with a resolution of 2 nm for a print pattern with the aid of a 256-element linear sensor, and the color of the print is detected by comparing the results with a reflection spectrum stored as a reference.

A method for comparing the color of a print on the basis of an RGB linear sensor output is disclosed in Japanese Patent Application Laid-open No. H06-246906, and a method in which a color TV is disposed at a position beyond the end of printing, a color image is transmitted to an operator in a control room, and the color is identified by the operator is disclosed in Japanese Patent Application Laid-open No. H11-207934.

Among these conventional methods, the method for directly measuring the color variations of a pattern makes it possible to determine that the pattern color has changed, but the method is still inconvenient for identifying the actual inks that have changed their color. Specifically, the problem is that although inspection is possible, the inspection results cannot be directly associated with control.

In current practice, the method for measuring the color of a color-patch printing portion can be used in an offline mode alone. For example, the line speed of gravure printing is commonly believed to be 200 m/min. A technique for measuring the color of a color patch portion at such a high speed has yet to be developed. For this reason, time is needed to feed back an ink color variation, and this leads to the production of numerous prints with irregular colors.

### SUMMARY OF THE INVENTION

With the foregoing in view, it is an object of the present invention to provide a colorimeter apparatus for a color printer ink whereby the color of a color patch portion can be rapidly measured in an online mode.

The first invention developed in order to attain the stated object relates to a calorimeter apparatus for a color printer ink designed to measure the ink color of a color printer in which a color patch is also printed on a print in order to identify the ink color, the apparatus comprising at least one light irradiation means for directing light at a specific angle to a specific irradiation area in the passing zone of a color patch on a moving print, a spectral unit including a spectral sensor and an optical system for measuring the spectral reflection intensity of light reflected from the irradiation area, spectral reflectance factor calculation means for calculating a spectral reflectance factor on the basis of signals from the spectral unit, and a signal processor for calculating a color or color difference on the basis of the calculated spectral reflectance factor and a stored formula for color systems or color differences, wherein the spectral unit has a Linear Variable Filter, a fiber optic plate or collimator, and a linear sensor.

The present invention is identical to the above-described conventional apparatus for measuring the color of a color patch in an offline mode in the sense that the color patch is irradiated with light, the reflected light is spectrally divided, the reflectance factor is calculated based on the results, and a color or color difference is calculated based on the reflectance factor and a stored formula for color systems or color differences.

The conventional apparatus operates on a principle whereby prisms or diffraction gratings are used as the spectroscope, and these are rotated to allow a single light sensor to receive diffracted light, or a principle whereby light spectrally divided by the prisms or diffraction gratings is received by a linear sensor. The first arrangement cannot be used in an online mode because of slow response, whereas the second arrangement is incapable of producing accurate measurements because of the inadequate intensity of light received by the linear sensor. Neither method can be used in an online mode because the measurement equipment is bulky and cannot be readily mounted on a printer.

The present invention is different from the conventional apparatus in that the spectral unit has a Linear Variable Filter, a fiber optic plate or collimator, and a linear sensor. The equivalent tunable filter (occasionally referred to hereinbelow as “LVF”) is a conventional optical element, as disclosed in Japanese Patent Application Laid-open No. H5-322635. When the light-receiving surface thereof is irradiated with light, the light with the wave length corresponding to the incident position is transmitted to the other side, allowing spectroscopy to be performed, and light to be spectrally divided with a higher wavelength resolution than 10 nm.

In the present invention, a fiber optic plate or collimator is interposed between the Linear Variable Filter and linear sensor, and light reflected from various parts of the Linear Variable Filter is guided toward a light-receiving surface of the linear sensor that corresponds to each part of the Linear Variable Filter.

The term “fiber optic plate” refers to a plate obtained by gathering together a large number of optical fibers with minute cross-sectional surface areas (commonly shaped as true hexagons with a maximum diagonal length of 6-25 μm). Light incident on a single optical fiber totally reflects from the interface between the core and cladding of the optical fiber, travels through the optical fiber, and reaches the other end face. This structure is described in “Fiber Optic Plates and Their Use” (Television Gakkai Gijutsu Hokoku, Sep. 28, 1990).

Employing a fiber optic plate as light transmission means in this manner allows light emitted by a Linear Variable Filter to be guided toward the position of a linear sensor or two-dimensional image sensor that corresponds to each part of the Linear Variable Filter while light absorption is minimized and light scattering prevented. Detecting each element output of the linear sensor makes it possible to spectrally divide the light incident on the light-receiving surface of the Linear Variable Filter. A spectrometric apparatus with excellent wavelength resolution, accuracy, and luminous energy transmissibility can thereby be obtained, making it possible to provide adequate response and rapid measurement even when the linear sensor or two-dimensional image sensor has high scanning speed. Differentiation can be performed during signal processing because the noises due to the differences between location-specific transmission efficiency are prevented from generating during light transmission. (The inventors have already filed for a patent (Japanese Patent Application No. 2001-78176) on a spectrometric apparatus operating on this principle.)

As described in detail below with reference to embodiments, the collimator according to the present invention has a property whereby light emitted by a minute section is separated from the light of an adjacent minute section and guided over a specific distance, allowing light emitted by a Linear Variable Filter to be guided toward the position of a linear sensor or two-dimensional image sensor that corresponds to each emission position of the Linear Variable Filter while light absorption is minimized and light scattering prevented. It is thus possible to obtain effects that are the same as or better than those afforded by the use of a fiber optic plate as a light transmission means.

Specifically, the spectral unit used in the present invention is a novel device whose spectral characteristic performance is more accurate than that of a spectral apparatus obtained by combining conventional Linear Variable Filters and linear sensors.

A spectral apparatus operating on this principle allows light to be spectrally divided with adequate accuracy and response speed because light of adequate intensity is guided toward the linear sensor. Consequently, the color of a color patch portion printed on a rapidly moving print can be measured in an online mode in accordance with the present invention.

Thus, adopting the present invention (1) makes it possible to instantaneously determine whether the correct ink color is used and to reduce the number of faulty products occurring at the start of printing.

(2) Ink color variations can be detected without stopping the line during the long time operation, making it possible to immediately adjust an ink color that has fallen outside the allowable range, to return the ink color to the desirable range, and to expect that the quality yield of the product will be improved.

(3) Extensive experience and sharp vision are needed to visually evaluate an ink color, placing considerable burden on the operator. With the online colorimeter of the present invention, colors can be consistently measured in a stable manner and the distribution of spectral reflectivity can be displayed together with the numerical values of the colors, allowing the operator of the printing line to easily monitor color variations and draw appropriate conclusions. It is thus easier for the operator to perform his duties. Numerous other merits can also be achieved.

The second invention developed in order to attain the stated object relates to a calorimeter apparatus for a color printer ink according to the first invention, wherein the spectral unit operates such that light reflected by the irradiation area is received by a telecentric lens system having an optical power of 4 or greater with a measurement distance of 65 mm or greater.

The dimensions of the color patch portion should preferably be minimized in order to minimize the size of the unproductive area on the print. A width of 6 mm and a length of 8 mm are the currently allowable dimensions. The currently obtainable Linear Variable Filters and linear sensors have a width of 2.5 mm and a length of 12.8 mm. Since a linear sensor must have a minimum scanning period of 1 msec, the color patch travels over a distance of 3.3 mm during this period, assuming that the travel speed of a print is 200 m/min. A 3.3-mm margin is also needed, assuming that the start timing of the scanning procedure has a 1-msec nonuniformity.

Consequently, the condition under which the same color of a color patch will remain in the field of view of a Linear Variable Filter during 1 msec is given by

(8−6.6)x>2.5,

where x is the optical power of the optical system for guiding reflected-light toward the Linear Variable Filter. The result is x>1.8.

The effective width of a color patch portion is 4 mm, assuming that the print meanders by ±1 mm. The optical power x must satisfy the condition 4x>12.8 to allow light from this area to cover the longitudinal direction of the Linear Variable Filter. The result is x>3.2.

Consequently, the optical power of the optical system for guiding reflected light toward the Linear Variable Filter should preferably be set to 4 or greater to allow for a certain margin.

The measuring distance (distance between the print and the tip of the optical system in the spectral unit) should preferably be set to 65 mm or greater because of equipment limitations. In addition, the optical system should preferably be a telecentric optical system in order to prevent measurements from being affected when the pass line of the print varies somewhat.

The third invention developed in order to attain the stated object relates to a colorimeter apparatus for a color printer ink according to the first or second invention, wherein the light irradiation means uses a xenon light source as the light source.

The light source should preferably have high energy between 400 and 700 nm wave length (which is the band in which the emission wavelength distribution is visible), low energy below 400 nm and above 700 nm wave length, and an emission spectrum with reduced intensity variations. In particular, increased energy in the near-infrared region does not present any problems when the print travels at a high speed, but there is a risk that the print will absorb the energy, become scorched, and ignite when at rest. A xenon light source with reduced energy in the near-infrared region should therefore be used.

The fourth invention developed in order to attain the stated object relates to a calorimeter apparatus for a color printer ink according to any of the first to third inventions, wherein the light irradiation means has an optical fiber for guiding the light of the light source, and a condenser lens provided at the tip of the optical fiber on the side facing the print.

The projecting unit (light irradiation means) must be small, have a short projecting distance, and be capable of condensing considerable luminous energy within a limited surface area. Even with a large light source, the present invention allows light emitted by the light source to be guided toward a measurement unit with the aid of a bundled optical fiber, to condense the light on the tip of the optical fiber with the aid of a condenser lens, and to direct the light to the passing zone of the color patch on the print. When an optical fiber alone is commonly used, light emitted by the optical fiber undergoes scattering, but providing a condenser lens at the tip of the optical fiber makes it possible to set the distance between the projector tip and the print to about 20-30 mm.

The fifth invention developed in order to attain the stated object relates to a colorimeter apparatus for a color printer ink according to any of the first to fourth inventions, wherein the light irradiation means comprises a light splitter for dividing in two the light output of the light source in the light irradiation means; one of the two divided light beams is directed to the passing zone of the color patch on the moving print; the other light beam is guided toward a light source emission spectrum measuring apparatus for measuring the emission spectrum of the light source; and the spectral reflectance factor calculation means has a function whereby the signal of the spectral unit is corrected using the signal from the light source emission spectrum measuring apparatus, and a spectral reflectance factor is calculated.

The spectral distribution of a light source for emitting a continuous spectrum often varies over time. For example, the spectral distribution of the xenon light source recommended for use in the present invention varies with voltage variations, heat fluctuations of the xenon gas, and the like. Voltage variations can be stabilized with high accuracy, but the heat fluctuations of the xenon gas are difficult to prevent. As a result of experiments, the inventors discovered that the repeat accuracy of the spectral reflectivity of a regular standard white surface has a standard deviation of about 0.5%. It is apparent that variations of the spectral distribution of a light source bring about variations in the spectral distribution of reflected light received from the same sample, creating color measurement errors.

By contrast, the present invention entails performing a procedure in which the light of a light source is divided in two, one of the light beams is used to spectrally divide the light reflected from the color patch portion on a print, the other light beam is spectrally divided by a spectroscope to produce an emission spectrum, and the spectral measurement value of light reflected from the color patch portion is corrected using the emission spectrum, yielding a spectral reflectance factor. Correct color measurements can therefore be carried out even when there are variations in the spectral distribution of the light source.

The present invention has been described with reference to a case in which the spectral reflectance factor calculation means corrects the signal of the spectral unit on the basis of the signal from the light source emission spectrum measuring apparatus and calculates a spectral reflectance factor, but this arrangement is not the only possible option, and it is also possible to adopt an arrangement in which the spectral reflectance factor is calculated using the signal of the spectral unit, and the spectral reflectance factor thus obtained is corrected using the signal from the light source emission spectrum measuring apparatus. It is apparent that this variation is equivalent to the present invention.

### BRIEF DESCRIPTION OF THE DRAWINGS

FIG. 1 is a diagram depicting the structure of an online calorimeter as a first embodiment of the present invention;

FIG. 2 is a diagram depicting an example of a print;

FIG. 3 is a diagram depicting an overview of a first type of spectral sensor;

FIG. 4 is a schematic of a capillary plate;

FIG. 5 is a diagram depicting a collimator fabricated using a thin metal sheet;

FIG. 6 is a diagram depicting the metal sheet used for the collimator shown in FIG. 5;

FIG. 7 is a diagram depicting the method for manufacturing the collimator shown in FIG. 5;

FIG. 8 is a diagram depicting an overview of a second type of spectral sensor;

FIG. 9 is a diagram depicting the emission spectrum of a xenon light source;

FIG. 10 is a flowchart depicting the functions (process specifics) of a signal calculation processing device 3;

FIG. 11 is a diagram depicting an overview of an online colorimeter as a second embodiment of the present invention;

FIG. 12 is a flowchart depicting the functions (process specifics) of a signal processing device 7; and

FIG. 13 is a diagram depicting the spectral reflectance factors of three paper samples (red, yellow, and blue) obtained in accordance with an embodiment of the present invention.

### DESCRIPTION OF THE PREFERRED EMBODIMENTS

Colorimeter apparatus for a color printer ink representing embodiments of the present invention will be described in detail below with reference to the accompanying drawings.

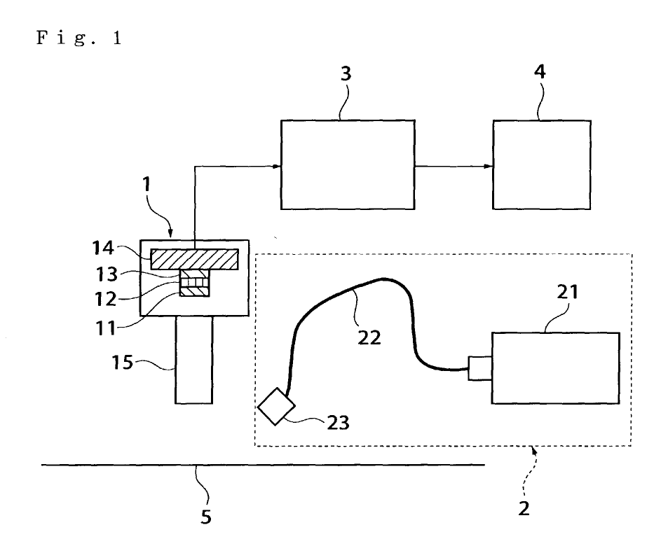

FIG. 1 is a diagram depicting the structure of an online colorimeter as a first embodiment of the present invention. The online colorimeter, which comprises a spectral unit 1, a projecting unit 2, a signal processor 3, and a calculation result display 4, measures the color of a color patch portion formed on a print 5.

The spectral unit 1 comprises a Linear Variable Filter (spectral portion) 11, a fiber optic plate (FOP) or collimator 12, a linear sensor (optoelectronic converter) 13, an analog signal generator 14, and a telecentric lens system (high-magnification image focusing lens system) 15. The projecting unit 2 comprises a xenon light source 21, an optical fiber 22, and a condenser lens 23.

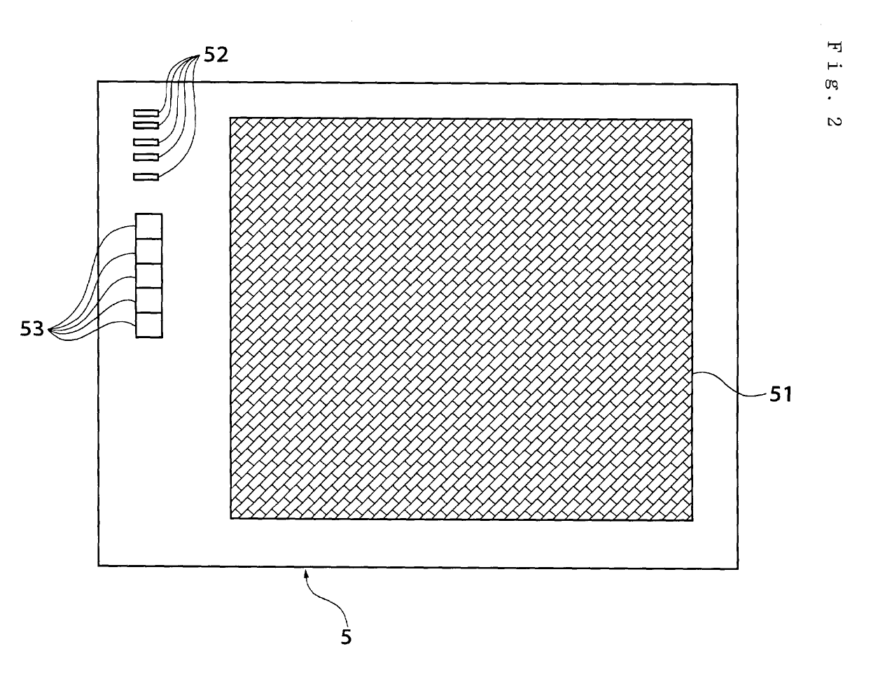

FIG. 2 depicts an example of a print. The drawing depicts the portion of a print corresponding to a single turn of the plate cylinder and consisting of an image portion 51, a register mark 52, and a color patch 53. In this example, printing is performed with five colors, and the register mark 52 and color patch 53 each comprise five markings that correspond to each ink color.

Five inks are continuously printed over an area measuring 6 mm×8 mm in the color patch 53. The print moves along the color patch 53 (in the drawing, in the vertical direction).

In the online colorimeter shown in FIG. 1, light from the xenon light source 21 of the projecting unit 2 is guided by the optical fiber 22 (bundled optical fiber) and projected to the passage area of the color patch 53 via the condenser lens 23, which is provided at the tip of the optical fiber 22. By the function of the condenser lens, it is possible to project the light of the xenon light source 21 in concentrated fashion onto a narrow surface area (12 mm×8 mm) of the color patch portion. Although this is not shown in the drawings, a reflecting mirror is provided to the reverse surface of the xenon light source 21, and the action of this reflecting mirror reduces the emission efficiency of light other than the light in the visible region. In this embodiment, the print is irradiated with light at an incline of 45°.

When the color patch 53 of the print 5 passes through the irradiation area, light is reflected in accordance with the corresponding ink color. The reflected light is condensed by the telecentric lens system 15 of the spectral unit 1, and an image of the print surface is formed on the light-receiving surface of the Linear Variable Filter 11. The light is spectrally divided by the Linear Variable Filter 11 and guided toward the linear sensor 13 via the fiber optic plate (FOP) or collimator 12. The outputs of the elements constituting the linear sensor 13 correspond to the spectral reflectance at different wavelengths.

These outputs are converted to analog signals by the analog signal generator 14 and are sent to the signal processor 3. A spectral reflectance factor is determined by the signal processor 3 on the basis of the resulting spectral reflectivity, and a color or color difference is calculated based on this value and on the pre-stored formulas for color systems or color differences. The calculation result is displayed on the calculation result display 4.

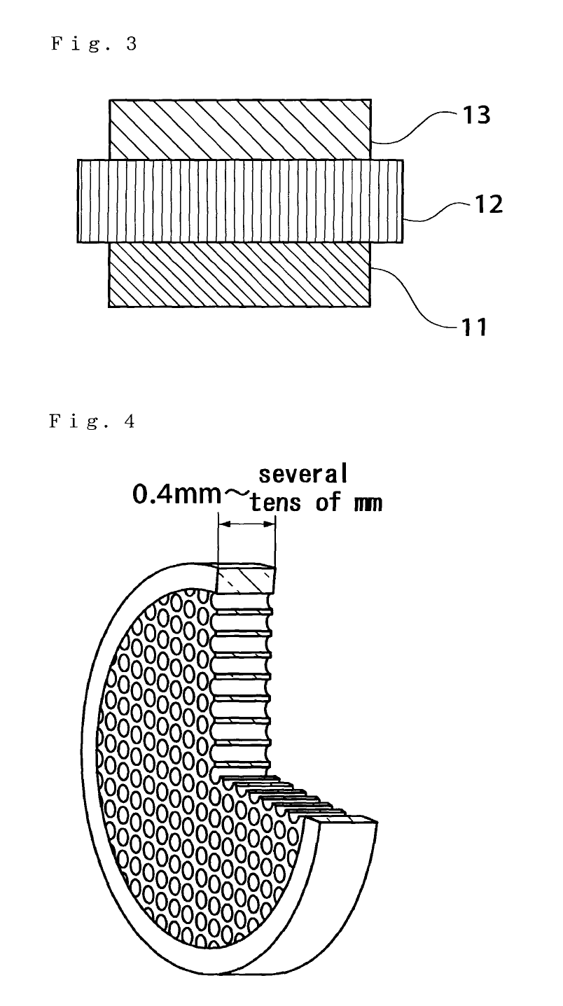

The spectral unit will now be described in detail. FIG. 3 depicts an overview of a first type of spectral sensor. A fiber optic plate 12 with a numerical aperture NA of 1.0 is mounted on the emission side of the Linear Variable Filter 11, and a linear sensor 13 is mounted on the opposite side of the fiber optic plate 12.

The spectral range of the Linear Variable Filter 11 is enabled between 365 and 735 nm, but the effective range is 400-700 nm. The linear sensor 13 is an Si sensor composed of 256 elements, with each pixel measuring 50 μm×2500 μm. The wavelength resolution of a single element is therefore 1.5 nm. This resolution is adequate, considering that the spectroscopes for commercially available online spectral colorimeters have a wavelength resolution of 10 nm.

Although a fiber optic plate 12 is used as a means for guiding the light output of the Linear Variable Filter 11 toward the linear sensor 13 in FIG. 3, a mechanical collimator may also be used in place of the plate. Devices with hollow glass tubes have been proposed as collimators with minute diameters.

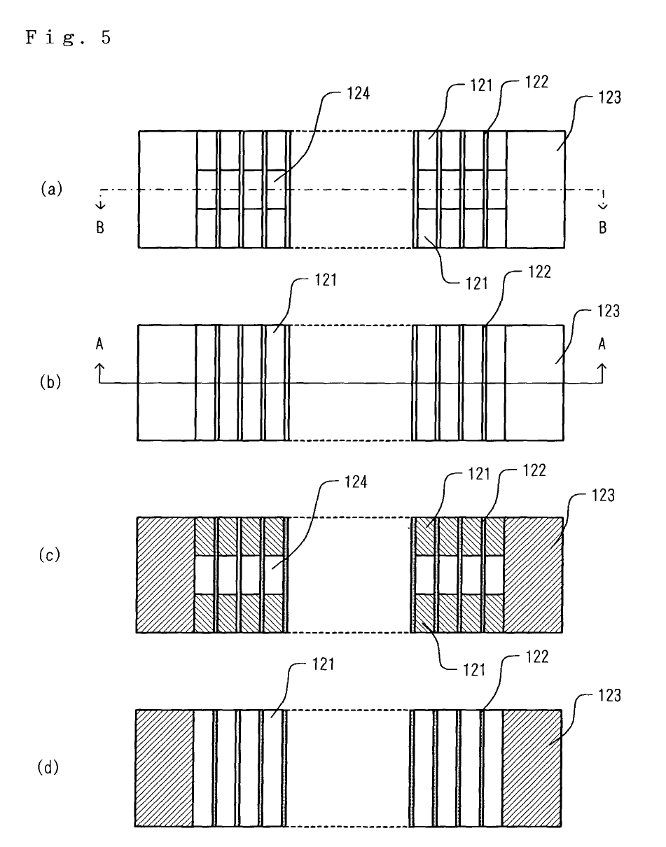

FIG. 4 is a schematic of the capillary plate described on the home page of Hamamatsu Photonics. The plate can be manufactured by providing glass with regularly arranged holes whose diameters range from several micrometers to several hundreds of micrometers, and the length thereof may range from 0.4 mm to several tens of millimeters.

Collimator functions can be obtained by coating the hollow portions of the capillary plate glass with absorbing or reflecting films. This method, however, reduces light transmissivity because the capillary plate can have aperture ratio of about 55% at best and because the openings have a round shape.

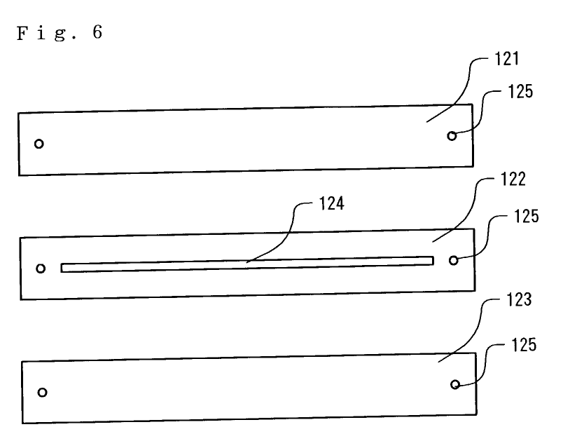

The inventors have also developed a high-performance collimator. The structure thereof is shown in FIG. 5. In FIG. 5, (a) is a plan view, (b) a front view, (c) an A-A cross-sectional view, and (d) a B-B cross-sectional view. The drawing is merely a schematic used to illustrate the structure, so the dimensions shown in the drawing do not correspond to actual dimensions.

It can be seen in the drawing that the collimator is constructed by alternately superposing metal sheets 121 (thickness: 40 μm) provided with holes 124 (width: 2200 μm) in the centers thereof, and metal sheets 122 (thickness: 10 μm) devoid of holes. The collimator is pressed on both sides by metal pressure plates 123 with a thickness of 2 mm. The metal sheets and pressure plates are joined together by thermocompression bonding.

The portions containing vertical through holes 124 (40 μm×2000 μm) thus become light-transmitting portions, the metal sheets 122 serve as partitions for adjacent holes 124, and a passage is ultimately formed for light collimated to a width of 40 μm. Any thin metal films can be used as long as these thin metal films are amenable to photoetching and are readily stackable. Relatively inexpensive, readily available, and highly strong SUS sheets were used in the case under consideration. The portions indicated by the dotted line in the drawing is omitted from the drawings because these portions have the same structure as the sections to the left and right. In the present embodiment, 256 metal sheets 121 are used, 255 metal sheets 122 are stacked, and 256 light passages are formed.

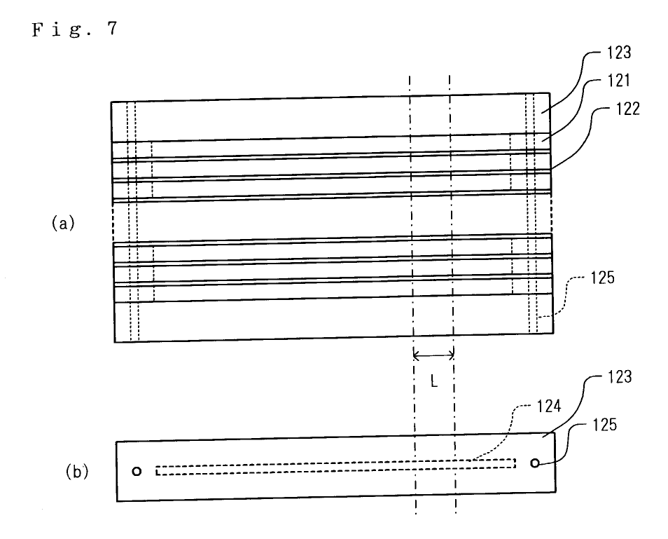

Since the collimator is a novel component, an example of the method for manufacturing this component will now be described. A thin SUS sheet 121 with a length of 100 mm, a width of 8 mm, and a thickness of 40 μm is prepared, as are a thin SUS sheet 121 with a thickness of 10 Rm and an SUS plate 123 with a length of 100 mm, a width of 8 mm, and a thickness of 2 mm. A hole 124 measuring 40 μm×2200 μm is formed by photolithography and etching in the center of the thin SUS sheet 121, as shown in FIG. 6. Two holes 125 with a diameter of 2 mm are bored by photolithography and etching in each of the thin SUS sheet 121 and thin SUS sheet 122, and by discharge machining in the SUS plate 123. Etching is used as the machining method in order to prevent burring.

The 40-μm thin SUS sheet 121 is then placed on the SUS plate 123 with the 2-mm thickness, and the thin SUS sheet 122 with the 10-μm thickness is stacked on top thereof. The thin SUS sheets measuring 40 μm and 10 μm are then alternately stacked. In the present example, 256 40-μm SUS sheets 121 are used, 255 10-μm SUS sheets 122 are stacked, and the SUS plate 123 with the 2-mm thickness is placed on top thereof. In the process, the plates are positioned using the holes 125 with the 2-mm diameters.

In this condition, the stacked sheets are not fixed in place and must therefore be joined together. In view of this, the contacting surfaces of the SUS sheets are joined together using a thermocompression bonding technique. For this reason, pressure is applied to the stack from above and below by pressure plates (a material that does not adhere to SUS is used), the stack is placed in a vacuum heating furnace in this state, the temperature is raised from room temperature to about 1000° C. and kept at this level, an assessment is made as to the time when diffusion bonding is completed, and the temperature is lowered. This thermal treatment takes about 24 hours. A joined multilayer sheet such as the one shown in FIG. 7 is thus completed. In FIG. 7, (a) is a plan view; (b), a side view.

The joined multilayer sheet is subsequently cut. The cutting position for cutting out a single collimator is shown by the chain line in FIG. 7. The cutting is accomplished by wire cutting/electric discharge machining. Because the sheets are joined together by diffusion bonding, clean cuts are obtained. A collimator with height L such as the one shown in FIG. 5 is thus obtained (the view from left to right in FIG. 7 corresponds to FIG. 5(a)). The height L of the collimator is determined by the cutting length shown in FIG. 7. An advantage of this fabrication method is that the collimator height can be machined to any level in the finishing stage. The L-value can be increased to satisfy high wavelength resolution requirements. The device may be provided with a reduced L-value to satisfy high speed requirements.

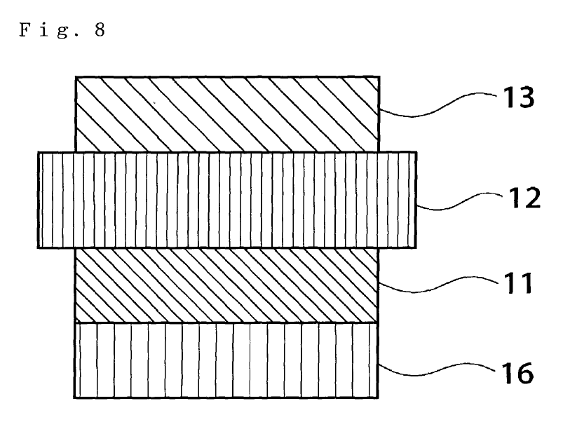

FIG. 8 depicts an overview of a second type of spectral sensor. A fiber optic plate 16 with an NA of 0.35 is placed on the light-admitting side of the Linear Variable Filter 11, and spectrally divided light is guided toward the linear sensor 13 via a fiber optic plate 12 with an NA of 1.0 on the emitting side.

In this system, it is possible to make the numerical aperture of light entering a fiber optic plate 16 small because the fiber optic plate 16 is disposed on the light-admitting side of the Linear Variable Filter 11, and also it is possible to guide the light efficiently from the Linear Variable Filter 11 toward the linear sensor 13 because a fiber optic plate 12 with a high numerical aperture is disposed on the emitting side of the Linear Variable Filter 11. Wavelength resolution can thereby be further enhanced. The above-described collimator may be used in the present embodiment instead of the fiber optic plate 12.

A light-receiving optical system will now be described. The color patch measures 6 mm×8 mm, and the sensor measures 12.8 mm×2.5 mm. For this reason, an optical system with power of 4 was selected for a telecentric lens system 14. The field of view of the measuring color patch 53 has a width of 3.2 mm and a length of 0.62 mm. With these dimensions, there is no danger that the field of view will fall outside the color patch area even when the width variations (individual variations) reach ±1 mm. The displacement will reach 3.3 mm if the travel speed is 200 m/min and the scan period is 1 msec, allowing reflected light that is representative of the color patch portion for each color to be securely measured if the linear sensor 12 is actuated at 1-msec periods. The print has a distance of 65 mm in relation to the lens of the telecentric lens system 14 used.

The optical axis of the light-receiving system is disposed at 0° in relation to the normal to the print on 4. At the same time, the optical axis on the projection side is disposed at 45° to the normal, as described above. This corresponds to the condition a (45-0), which is one of the geometrical illumination and light reception conditions specified in JIS Z 8722.

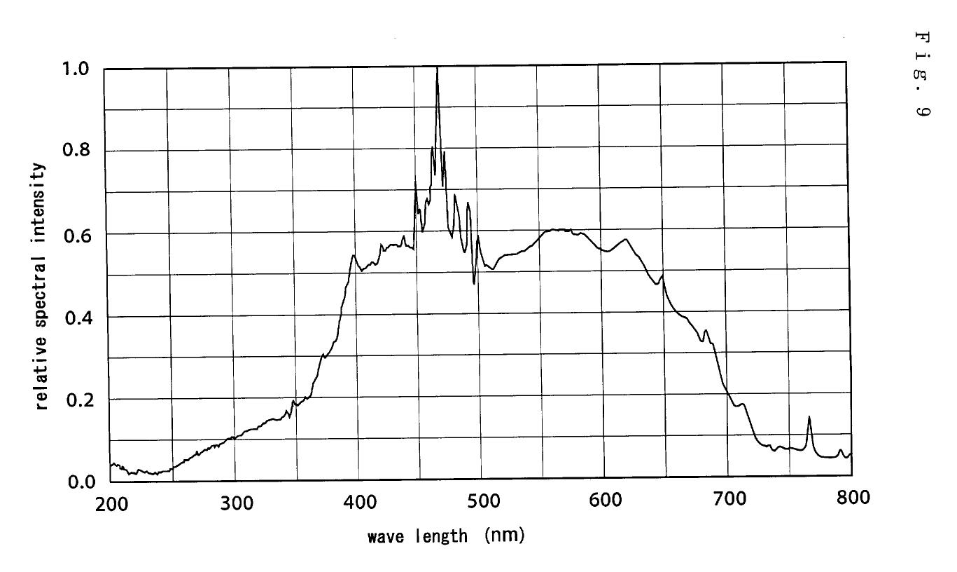

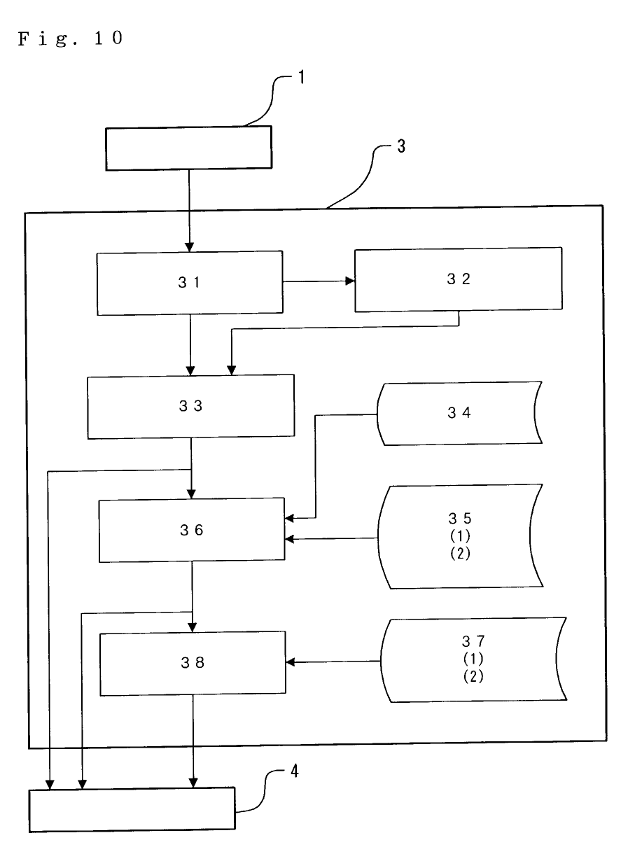

The projecting unit 2 (light irradiation means) will now be described. An expensive infrared cutoff filter must be used for a common xenon light source. using an infrared cutoff filter is not always successful in terms of cutoff, and highly absorptive paper samples are scorched and caused to emit smoke when continuously irradiated. In view of this, an LCS-series light source (a xenon light source manufactured under the registered trade name LIGHTNINGCURE by Hamamatsu Photonics) whose emission distribution differs from that of the sources used for illumination, UV curing, or the like is used in the present embodiment as a special xenon light source 21 devoid of such drawbacks. The emission spectrum of such a source is shown in FIG. 9. Although this light source lamp is an ordinary xenon lamp, the specially designed reflecting plate with special absorption characteristics is provided for cutting off the ultraviolet and near-infrared regions of emitted light.

The light source used herein is 150 W, but the spectrum has optimal distribution for color measurements, the paper is not scorched, and reflectivity can be measured even during continuous irradiation.

The xenon light source used herein is designed for UV curing applications, allowing optical fibers to be connected. An arrangement is therefore adopted in which an optical fiber (bundled) 22 is used, a condenser lens 23 is attached to the tip thereof, and the measuring field of view of the color patch 53 can be irradiated

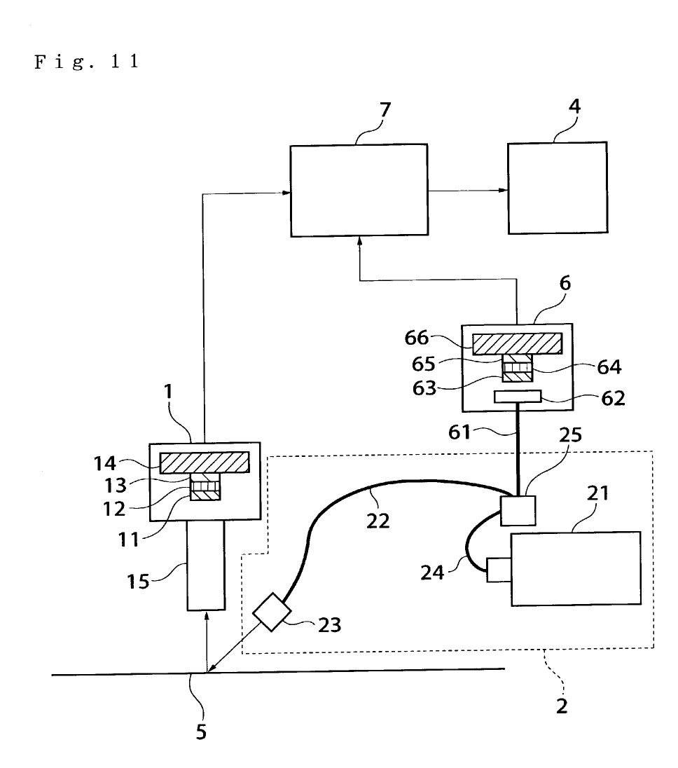

The functions of the signal calculation processing device 3 will now be described using the flowchart shown in FIG. 10.

In FIG. 10, each symbol corresponds to the following component or function.

1 SPECTRAL SENSOR

3 SIGNAL PROCESSOR

4 CALCULATION RESULT DISPLAY

31 REFLECTION SPECTRAL DATA ARE DIGITALLY PROCESSED

32 REFLECTION INTENSITY SPECTRAL VALUES OF REGULAR REFERENCE WHITE SURFACES ARE STORED

33 SPECTRAL REFLECTANCE FACTOR OF COLOR PATCH ON PRINT IS CALCULATED

34 SPECTRAL DISTRIBUTION OF LIGHT SOURCE COLORS BASED ON COLOR CALCULATION

35 (1) COLOR-MATCHING FUNCTIONS OF XYZ COLOR SYSTEM

(2) COLOR-MATCHING FUNCTIONS X₁₀, Y₁₀, Z₁₀

36 CALCULATION OF TRISTIMULUS VALUES X₁₀, Y₁₀, Z₁₀

37 FORMULA FOR CALCULATING COLOR DIFFERENCES AND COLORS FOR EXPRESSING COLOR SPACES

(1) L*, a*, b* SYSTEM

(2) L*, u*, v* SYSTEM

38 COLOR SPACE EXPRESSION AND COLOR DIFFERENCE CALCULATION

The color measurement method is defined in Japanese Industrial Standard JIS Z 8722. This spectral colorimetric method should be adhered to, and the optical system and reflectivity measurement method used in the present embodiment is based on this standard.

Consequently, the spectral reflectance factor of each ink can be determined by storing the spectral reflection intensity of a regular reference white surface as the output value of the digital signal processing circuit, measuring the spectral reflection intensity of the color patch portion of the print, and dividing the result by the stored value.

Once the spectral reflectance factor is determined, the tristimulus values X, Y, and Z of an XYZ color system are determined by a color calculating/processing apparatus in accordance with the formula defined in JIS Z 8722. In current practice, an X₁₀Y₁₀Z₁₀ color system with a 10° field of view is often used. In conventional practice, the values of various types of color systems can be calculated based on these tristimulus values and predetermined light source color spectra. Notation involving L*, a*, and b* is currently used on a wide scale, and the color difference is expressed as ΔE*ab.

Multicolor printing with 4-8 colors is primarily used in gravure printing. Consequently, 4-8 color patches are continuously printed. The start point of a color patch repeatedly printed with each plate cylinder is therefore synchronously read out on the basis of pulse signals from a position detector and an encoder attached to the cylinder, the position printed by each color is then determined, and the reflectivity signal of the spectroscope in this area is read out.

An analog signal sent from a spectral sensor 1 is converted to a digital signal by the digital processing of reflection spectral data with the aid of the signal calculation processing device 3 (31).

The reflectivity spectrum of a regular reference white surface must be determined before an online measurement is started. This is accomplished by a procedure in which the measuring instrument is moved to a position outside the range of movement of the print, a regular reference white surface is placed at the position the measuring instrument measures color , and the reflection spectrum thereof is measured. The reflection spectrum of the regular reference white surface is stored in a unit for storing the reflection intensity spectra of regular reference white surfaces (32).

Data processing performed during online measurement will be described next. The data converted to a digital signal by the digital conversion processing 31 of reflection spectral data are used for the spectral reflectivity calculation processing 33 of color patches. A spectral reflectance factor R (k) is determined with the aid of the spectral reflectivity calculation processing 33 of the color patch under measurement by dividing the reflection spectrum data for the measured color patch by the spectral data for a regular reference white surface stored in the unit for storing the reflection intensity spectra of regular reference white surfaces.

Tristimulus values X₁₀, Y₁₀, and Z₁₀ are determined by performing processing 36 for calculating the tristimulus values X₁₀, Y₁₀, and Z₁₀ on the basis of the spectral distribution 34 of the light source colors used for color calculation and stored in advance, and on the basis of the spectral reflectance factor R (λ) determined with the aid of a color-matching function 35 and the spectral reflectivity calculation processor 33.

Relative spectral distributions of reference light A, reference light C and reference light D₆₅ are described in an attachment to JIS Z 8701 for light source colors. The type of light source may be selected in accordance with the measurement object, and D₆₅ is selected for the present embodiment.

The color-matching functions x(λ), y(λ), and z(λ) of an XYZ color system corresponding to a 2-degree field of view, and the color-matching functions x₁₀(λ), y₁₀(λ), and z₁₀(λ) of an X₁₀Y₁₀Z₁₀ color system with a 10-degree field of view are defined and cited as color systems in JIS. In the present embodiment, the calculation is performed using the color-matching functions of an X₁₀Y₁₀Z₁₀ color system with a 10-degree field of view. (Although this information is available in JIS Z 8722, the main formulas are shown below.)

X₁₀=K∫₃₈₀⁷⁸⁰S(λ)x₁₀(λ)R(λ)dλ

Y₁₀=K∫₃₈₀⁷⁸⁰S(λ)x₁₀(λ)R(λ)dλ

Z₁₀=K∫₃₈₀⁷⁸⁰S(λ)x₁₀(λ)R(λ)sλ

$$K = \frac{100}{{\int }_{380}^{780} S ( λ ) {y}_{10} ( λ ) ⅆ λ}$$

where S(λ) is the spectral distribution of reference light (D65, C, A) or another type of light used to express colors; x₁₀(λ), y₁₀(λ), and z₁₀(λ) are color-matching functions for an X, Y, Z color system; and R(λ) is the spectral reflectance factor.

In color difference calculation processing 38, the numerical values L*, a*, and b* required for expressing color differences are calculated by a procedure in which the results obtained by the processing 36 for calculating the tristimulus values X₁₀, Y₁₀, and Z₁₀ are substituted into a pre-stored formula 37 for calculating color differences and color space expressions.

The main formulas are shown below.

L*=116(Y₁₀/Yₙ₁₀)/^{1/3}−16

a*=500[(X₁₀/Xₙ₁₀)/^{1/3}−(Y₁₀/Yₙ₁₀)^{1/3}]

b*=500[Y₁₀/Yₙ₁₀)^{1/3}−(Z₁₀/Zₙ₁₀)^{1/3}]

(X₁₀/Yₓ₁₀)>0.008856, (Y₁₀/Yₙ₁₀)>0.008856, (Z₁₁/Zₙ₁₀)>0.008856

The L*a*b* system, L*u*v* system, or the like can be used as a color space expression (refer to entries 2063 and 2070 in the JIS Z 8105 glossary). The L*a*b* system is used in the present embodiment.

The color difference ΔE*ab is calculated based on ΔL*, Δa*, and Δb* in order to determine the color change (color difference) between different moments. In view of this, storing the numerical values L*, a*, and b* required for determining past color difference expressions constitutes part of the calculation processing in 38, and these stored data are used to calculate the color difference ΔE*ab on the basis of ΔL*, Δa*, and Δb* as needed. (The formulas are described in JIS 8730.)

In gravure printing, approximately 4-8 colors are used for the color patches. Five colors are depicted in the example shown in FIG. 2. The reflection spectra of these five colors is first measured, and the spectrum having the correct position is used in the calculation. The spectral reflectance factor R (λ); tristimulus values X₁₀, Y₁₀, and Z₁₀; color space expression values L*, a*, and b*; color difference ΔE*ab; and other parameters of the five colors are calculated. These calculations are completed before the arrival of the image belonging to the next plate cylinder.

The calculation result display 4 depicted in FIG. 1 will now be described. The calculation result display 4 receives the spectral reflectance factor R (i); tristimulus values X₁₀, Y₁₀, and Z₁₀; color space expression values L*, a*, and b*; color difference ΔE*ab; and other calculation results from the signal processor 3, and outputs these results to a monitor display or a printer.

The high efficiency of spectral calculations allows the spectral reflectance factor to be displayed. In the particular case of the present invention, variations can be identified based on the waveform configuration because of the high wavelength resolution (1.5 nm). Specifically, minute variations can be visually identified by storing and displaying reference reflectivity distribution data and superposing measurement results thereon. It is also easy to mathematically express the extent of these variations.

The calculation result display 4 graphically represents the tristimulus values X₁₀, Y₁₀, and Z₁₀; the color space expression values L*, a*, and b*; the color difference ΔE*ab; and other numerical values and variations thereof over time. These are assigned abnormality limits in advance, and when these limits are exceeded, a warning is issued to the operator by the display of a color image on a monitor, the generation of a sound signal, or some other method.

Experimental results obtained by the inventors indicate that when a spectral unit such as the one shown in FIG. 8 was used in the above embodiment, a value of ±0.5% was obtained for the repeat accuracy of measurement values expressed as the standard deviation of the reflection spectrum of a regular reference white surface. This result is adequate for the online use of a calorimeter apparatus for a color printer ink.

In a common color difference meter, however, the requirement for the standard deviation of the reflection spectrum of a regular reference white surface is believed to be no more than ±0.2%, an accuracy unattainable with the above-described embodiment. In view of this, the inventors conducted a study into the possibility of adding further improvements and researched the factors that have an adverse effect on the repeat accuracy of measurement values, whereupon it was discovered that these factors are related to variations in the emission intensity of a xenon light source. The variations in the emission intensity of a xenon light source can be reduced by improving the stability of the power supply, but rapid continuous measurements of about 1 msec make such stabilization difficult because luminous energy variations due to the temperature fluctuations of xenon gas are expected to be more significant than the variations of a power supply. Consequently, the inventors devised a method for compensating for the variations in the emission intensity of a xenon light source by designing a separate structure.

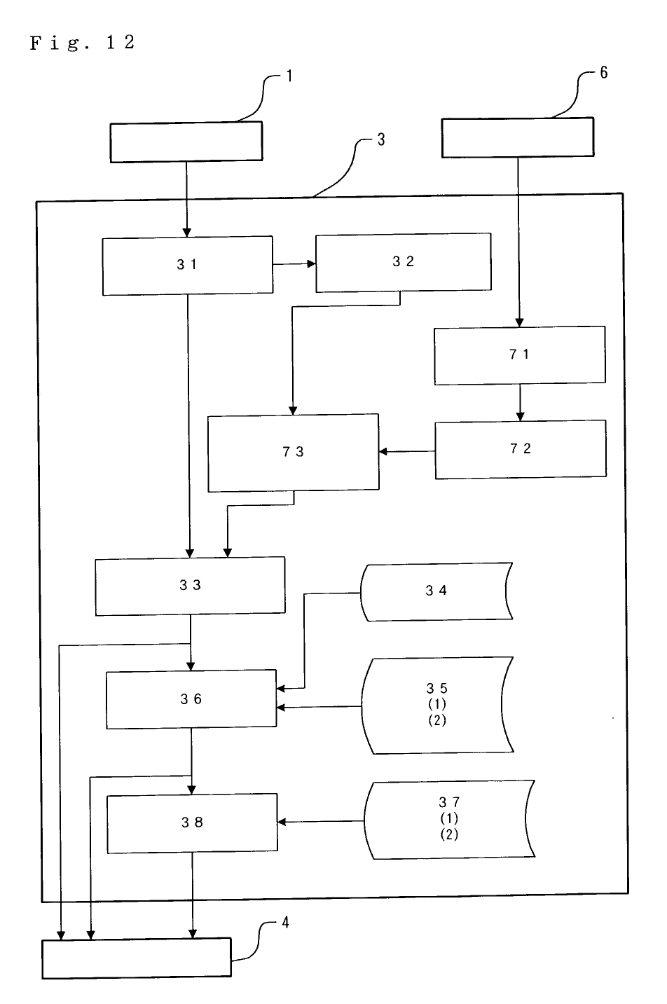

FIG. 11 is a schematic of an online colorimeter configured in accordance with a second embodiment of the present invention and designed to compensate for variations in the high emission intensity of a xenon light source. The basic portion of the embodiment shown in FIG. 11 is the same as that of the embodiment shown in FIG. 1. What is different, however, is that the structure of the projecting unit 2 is partially modified, a light source emission spectrometer 6 is added, and the output thereof is entered to the signal processing calculator 7. The portions whose structure is similar to FIG. 1 will therefore be omitted from the description, and only the structures that are different from FIG. 1 will be described.

The light of a xenon light source 21 is directed to an optical fiber 24, guided toward an optical fiber splitter 25, and divided there between an optical fiber 22 and an optical fiber 61. The light diverted to the optical fiber 22 is used for illuminating a print 5, as described above. The light diverted to the optical fiber 61 is guided toward the light source emission spectrometer 6.

The light source emission spectrometer 6 comprises a diffuser 62, a Linear Variable Filter 63, a fiber optic plate 64, a linear sensor (optoelectronic converter) 65, and an analog signal generator 66.

The light guided by the optical fiber 61 is diffused by the diffuser 62, spectrally divided by the Linear Variable Filter 63, directed to the linear sensor 65 via the fiber optic plate 64, optoelectronically converted, converted to an analog signal by the analog signal generator 66, and transmitted to the signal processing device 7.

The respective analog signal generator 14 and 66 of the spectral unit 1 and light source emission spectrometer 6 are energized according to the same timing, and the outputs thereof are entered into the signal processing device 7.

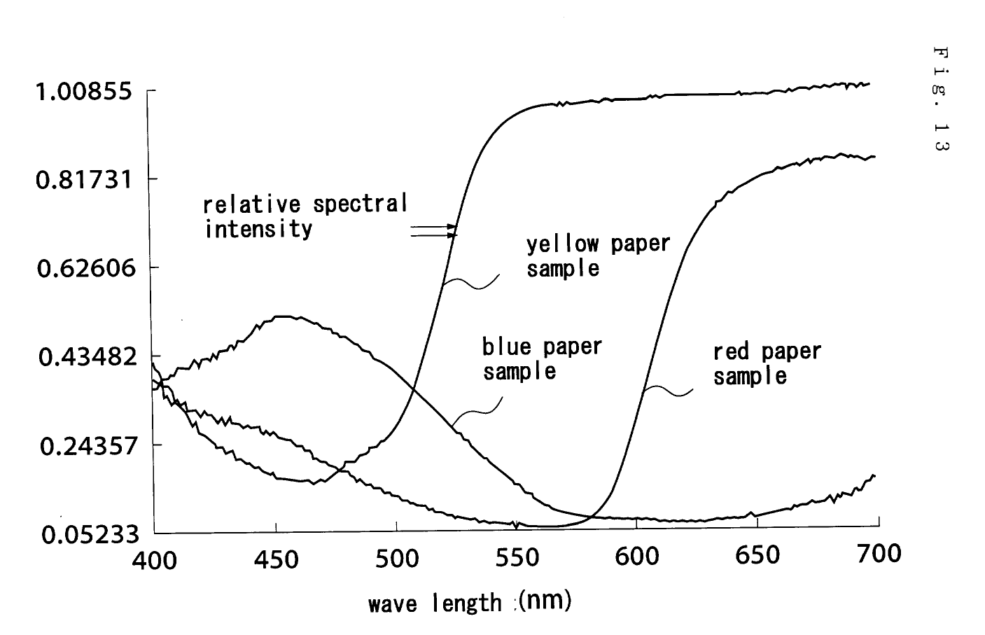

The processing specifics of the signal processing device 7 configured according to the embodiment depicted in FIG. 11 will now be described with reference to the flowchart shown in FIG. 12. The processing specifics shown in FIG. 10 and the processing specifics shown in FIG. 12 are substantially the same. The sole difference between the two is that digital conversion processing 71 for light source spectral data, processing 72 for calculating the rate of change of light source spectra, and processing 73 for the corrective calculation of the reflection intensity of a regular reference white surface are added to the processing shown in FIG. 12. In the description that follows, the identical portions will be omitted and the added portions alone will be described.

In FIG. 12, each symbol corresponds to the following component or function.

1 SPECTRAL SENSOR

3 SIGNAL PROCESSOR

4 CALCULATION RESULT DISPLAY

6 LIGHT SOURCE EMISSION SPECTROMETER

31 REFLECTION SPECTRAL DATA ARE DIGITALLY PROCESSED

32 REFLECTION INTENSITY SPECTRAL VALUES OF REGULAR REFERENCE WHITE SURFACES ARE STORED

33 SPECTRAL REFLECTANCE FACTOR OF COLOR PATCH ON PRINT IS CALCULATED

34 SPECTRAL DISTRIBUTION OF LIGHT SOURCE COLORS BASED ON COLOR CALCULATION

35 (1) COLOR-MATCHING FUNCTIONS OF XYZ COLOR SYSTEM

(2) COLOR-MATCHING FUNCTIONS X₁₀, Y₁₀, Z₁₀

CALCULATION OF TRISTIMULUS VALUES X₁₀, Y₁₀, Z₁₀

FORMULA FOR CALCULATING COLOR DIFFERENCES AND COLORS FOR EXPRESSING COLOR SPACES

(1) L*, a*, b* SYSTEM

(2) L*, u*, v* SYSTEM

38 COLOR SPACE EXPRESSION AND COLOR DIFFERENCE CALCULATION

71 LIGHT SOURCE SPECTRAL DATA ARE DIGITALLY CONVERTED

73 CALCULATION OF RATE OF CHANGE OF LIGHT SOURCE SPECTRA

73 REFLECTION INTENSITY OF REGULAR REFERENCE WHITE SURFACE

IS CORRECTED AND CALCULATED BASED ON THE RATE OF CHANGE

OF LIGHT SOURCE SPECTRA

The signal processing device 7 converts the analog signal from the light source emission spectrometer 6 into a digital value when the reflection intensity spectrum of a regular reference white surface is measured in an offline mode (71). This value is stored during processing 72 for calculating the rate of change of light source spectra. When a print is measured in an online mode in the course of processing 72 aimed at calculating the rate of change of light source spectra, the digitally converted signal of the light source emission spectrometer 6 is compared with the signal obtained when the reflection intensity spectrum of a stored regular reference white surface is measured, and the rate of change of light source spectral data is constantly calculated. The reflection intensity data of the regular reference white surface stored in the unit for storing the reflection intensity spectra of regular reference white surfaces are corrected using the rate of change of the light source spectra.

The varying wavelength distribution or intensity of a light source is thus measured in the course of online measurements, and the reflection intensity data of a regular reference white surface is adjusted to compensate for the variations. The reflection intensity data of a regular reference white surface are used as reference values for calculating the spectral reflectance factor of a color patch on a print, so the spectral reflectance factor of the color patch on the print can always be calculated using correct reference values by correcting intensity data of a regular reference white surface on the basis of the measurement values of light emitted by an actual light source. Consequently, the present embodiment allows short- and long-term variations in a light source to be corrected even when the wavelength distribution or intensity of the light source varies during measurement, making it possible to prevent color measurements involving color patches from being affected by such variations and to obtain correct measurement results.

The calorimeter apparatus for a color printer ink configured in accordance with this embodiment was used to perform continuous measurements in an offline mode and to determine the extent of variations of the spectral reflectance factor of a regular reference white surface, whereupon the standard deviation was reduced to ±0.1%. Since the first embodiment yielded a value of ±0.5%, it is apparent that the effect of the double-beam system is significant.

To confirm the validity of this effect, variations of the spectral reflectance factors of regular reference white surfaces were measured while the luminous energy of the xenon light source was changed within a range of 80-100%. It was confirmed that whereas the systems of the first embodiment had a standard deviation of ±7%, the system of the second embodiment, which was based on a double-beam principle, was able to deliver a lower deviation (±0.2%).

### EXAMPLES

The colors of color patches were measured by a calorimeter apparatus for a color printer ink that operated on a double-beam principle such as the one described with reference to the second embodiment. FIG. 13 shows the measured spectral reflectance factors of three representative color paper samples (red, yellow, and blue). The wavelength range is 400-700 nm, shown at a resolution of 1.5 nm.

Table 1 shows the mean values and standard deviations of various types of calculation data related to the color paper samples. It can be seen that because the standard deviations of the red, yellow, and blue ΔE*ab values are small (0.44, 0.13, and 0.25, respectively), the system can adequately perform as an online color difference meter.

TABLE 1

| color | | X10 | Y10 | Z10 | L* | a* | b* | ΔE_{ab} |
|---|---|---|---|---|---|---|---|---|
| red | mean | 23.167 | 14.344 | 23.077 | 41.914 | 47.140 | −14.075 | . . . |
| | S.D | 0.241 | 0.123 | 0.062 | 0.160 | 0.316 | 0.261 | 0.440 |
| yellow | mean | 67.930 | 67.896 | 19.069 | 80.032 | 7.557 | 58.493 | . . . |
| | SD | 0090 | 0.098 | 0.055 | 0.045 | 0.025 | 0.120 | 0.131 |
| blue | mean | 14.288 | 17.629 | 45.789 | 45.909 | −12.970 | −35.633 | . . . |
| | S.D. | 0.102 | 0.154 | 0.278 | 0.176 | 0.179 | 0.039 | 0.252 |

S.D: Standard Deviation

What is claimed is:

1. A calorimeter apparatus for a color printer ink designed to measure the ink color of a color printer in which a color patch is also printed on a print in order to identify the ink color, said apparatus comprising at least one light irradiation means for directing light at a specific angle to a specific irradiation area in the passing zone of a color patch on a moving print; a spectral unit including a spectral sensor and an optical system for measuring the spectral reflection intensity of light reflected from the irradiation area; spectral reflectance factor calculation means for calculating a spectral reflectance factor on the basis of signals from the spectral unit; and a signal processor for calculating a color or color difference on the basis of the calculated spectral reflectance factor and a stored formula for color systems or color differences, wherein the spectral unit has a Linear Variable Filter, a fiber optic plate or collimator, and a linear sensor.

2. The calorimeter apparatus for a color printer ink according to claim 1, wherein the spectral unit operates such that light reflected by the irradiation area is received by a telecentric lens system having an optical power of 4 or greater with a measurement distance of 65 mm or greater.

3. The calorimeter apparatus for a color printer ink according to claim 1, wherein the light irradiation means uses a xenon light source as the light source.

4. The calorimeter apparatus for a color printer ink according to claim 1, wherein the light irradiation means has an optical fiber for guiding the light of the light source, and a condenser lens provided at the tip of the optical fiber on the side facing the print.

5. The colorimeter apparatus for a color printer ink according to claim 1, wherein said light irradiation means comprises a light splitter for dividing in two the light output of the light source in the light irradiation means; one of the two divided light beams is directed to the passing zone of the color patch on the moving print; the other light beam is guided toward a light source emission spectrum measuring apparatus for measuring the emission spectrum of the light source; and the spectral reflectance factor calculation means has a function whereby the signal of the spectral unit is corrected using the signal from the light source emission spectrum measuring apparatus, and a spectral reflectance factor is calculated.

6. The calorimeter apparatus for a color printer ink according to any of claim 2, wherein said light irradiation means comprises a light splitter for dividing in two the light output of the light source in the light irradiation means; one of the two divided light beams is directed to the passing zone of the color patch on the moving print; the other light beam is guided toward a light source emission spectrum measuring apparatus for measuring the emission spectrum of the light source; and the spectral reflectance factor calculation means has a function whereby the signal of the spectral unit is corrected using the signal from the light source emission spectrum measuring apparatus, and a spectral reflectance factor is calculated.

7. The calorimeter apparatus for a color printer ink according to any of claim 3, wherein said light irradiation means comprises a light splitter for dividing in two the light output of the light source in the light irradiation means; one of the two divided light beams is directed to the passing zone of the color patch on the moving print; the other light beam is guided toward a light source emission spectrum measuring apparatus for measuring the emission spectrum of the light source; and the spectral reflectance factor calculation means has a function whereby the signal of the spectral unit is corrected using the signal from the light source emission spectrum measuring apparatus, and a spectral reflectance factor is calculated.

8. The calorimeter apparatus for a color printer ink according to any of claim 4, wherein said light irradiation means comprises a light splitter for dividing in two the light output of the light source in the light irradiation means; one of the two divided light beams is directed to the passing zone of the color patch on the moving print; the other light beam is guided toward a light source emission spectrum measuring apparatus for measuring the emission spectrum of the light source; and the spectral reflectance factor calculation means has a function whereby the signal of the spectral unit is corrected using the signal from the light source emission spectrum measuring apparatus, and a spectral reflectance factor is calculated.
